(19) United States
(12) Patent Application Publication
(10) Pub. No.: US 2009/0029723 A1
(43) Pub. Date: Jan. 29, 2009

(54) MOBILE MULTIMEDIA DELIVERY

(75) Inventors: Eric Doyle, Ottawa (CA); Nicholas Eastridge, Princeton, NJ (US)

Correspondence Address: LAUBSCHER & LAUBSCHER, P.C., 1160 SPA ROAD, SUITE 2B, ANNAPOLIS, MD, 21403, US

(73) Assignee: Impatica Inc, Ottawa (CA)

(21) Appl. No.: 10/593,998

(22) PCT Filed: Mar. 22, 2005
(86) PCT No.: PCT/CA2005/000422

§ 371 Date: Sep. 29, 2008

(30) Foreign Application Priority Data
Mar. 22, 2004 (CA) 2461638

(51) Int. Cl. H04Q 7/20

(52) U.S. Cl. 455/466

(57) ABSTRACT

A method of preparing MMS messages involves preparing a multimedia presentation on a computer using an industry-standard multimedia format; exporting a file containing said multimedia presentation in said industry-standard format; and processing said file to create an MMS message suitable for transmission over a mobile phone service.

### FIELD OF THE INVENTION

This invention relates to the field of the delivery of multimedia services over mobile communication links, and in particular to methods for preparing multimedia content for such services.

### BACKGROUND OF THE INVENTION

SMS (short message service) is now well established and permits users to send short text messages over mobile phones. MMS (Multimedia Messaging Service) is now becoming popular as a method of delivering messages rich in multimedia content to mobile phone users. It is expected that the market for MMS will grow very rapidly in the near future. There is therefore a need to permit users to create MMS messages quickly and efficiently.

### SUMMARY OF THE INVENTION

The present invention provides a method of preparing MMS messages from industry-standard PC-based multimedia standards. In the preferred embodiment, Powerpoint presentations are prepared on a PC and automatically converted into MMS format.

In according with the present invention there is provided a method of preparing MMS messages comprising preparing a multimedia presentation on a computer using an industry-standard multimedia form at; exporting a file containing said multimedia presentation in said industry-standard format; and processing said file to create an MMS message suitable for transmission over a mobile messaging service, such as a mobile phone service.

In a preferred embodiment, the invention comprises the following steps:

1. Take a multimedia file with graphics, animation and sound, that was initially authoured in a proprietary format using a proprietary tool for personal computer authouring (e.g., PowerPoint).
2. Transform it into an intermediate format (Impatica file) more suitable for cross-platform delivery, preserving graphics, sound, sprite-based animation and other animation effects (and video, where applicable).
3. Transform and optimize the result to make it suitable for delivery to and playback on resource constrained mobile devices such as 2.5G and 3G mobile phones using standards based options such as MMS, J2ME MIDP and PersonalJava.
4. In the context of MMS, optimize multiple output targets to accommodate differing capabilities of mobile phones models, network operators (e.g., message size limits of 30 KB, 50 KB and 100 KB, or differing support of AMR audio). Perform selection for MMSC of the most appropriate output based on mobile phone profile when message is received.

The present approach has the following significant features:
1. MMS client software is pre-installed on the mobile device;
2. Industry standard file formats are used to represent MMS content, not proprietary file formats.
3. MMS messages are typically sent to recipients via a WAP push type mechanism, not pulled from a web site.
4. Content may be subjected to transformation on the network via transcoding and content adaptation (which could possibly adversely impact the quality of the viewing experience) that's beyond the realm of control of Impatica.
5. Varying screen dimensions/characteristics on different models of mobile phones significantly affects message creation, delivery and viewing.
6. Initially, MMS message size restrictions (from 30 KB up to 100 KB) imposed by handset manufacturers and network operators will severely limit the amount of content per message.

In another aspect the invention provides a method of compressing images, comprising comparing a subsequent sequence of pixels with previous sequences of pixels to find a match; and identifying the subsequent sequence of pixels by an offset relative to said previous sequence of pixels.

### DETAILED DESCRIPTION OF THE PREFERRED EMBODIMENTS

The invention will now be described in more detail, by way of example only, with reference to the accompanying drawings, in which:—

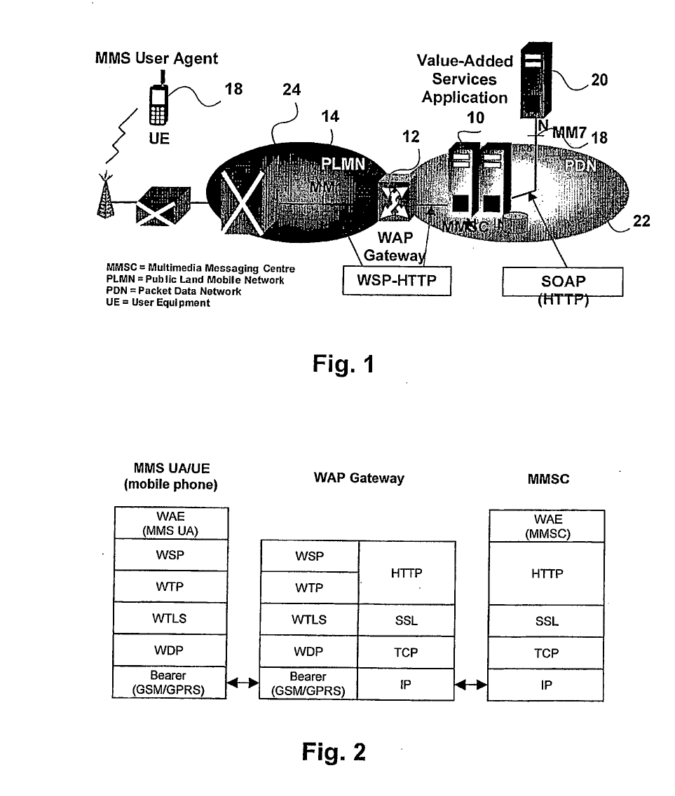

FIG. 1 illustrates a Multimedia messaging service architecture;

FIG. 2 shows the Protocol stacks for WAP MMS1.0;

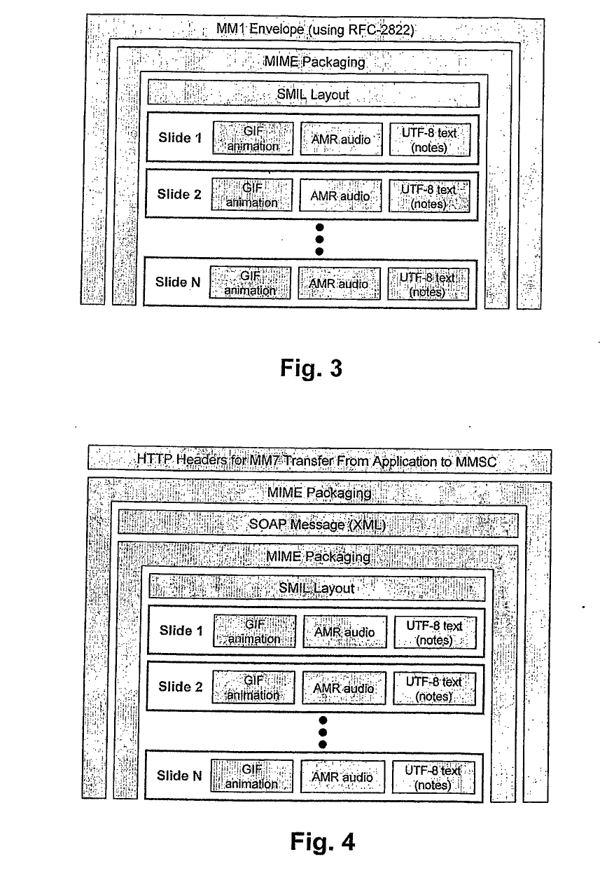

FIG. 3 shows the MMS message structure for the MM1 interface;

FIG. 4 shows the MMS message structure for the MM7 interface;

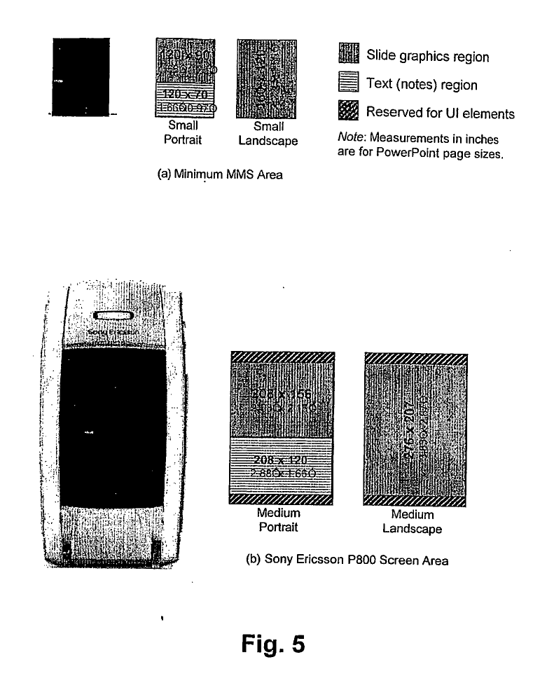

FIG. 5 shows the MMS display and message region dimensions; and

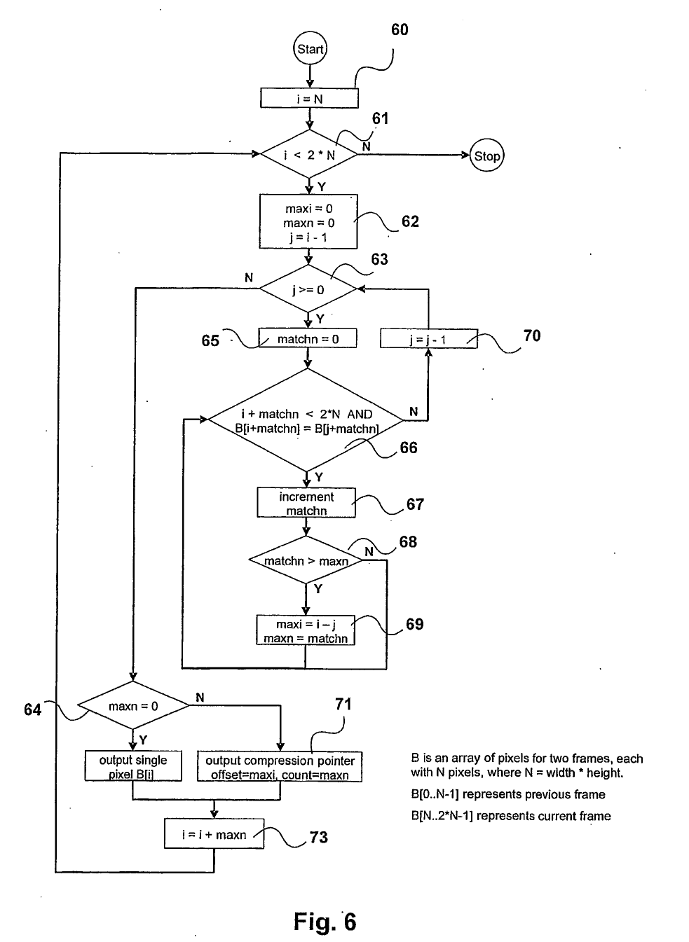

FIG. 6 is a flow-chart illustrating one embodiment of a compression method in accordance with the invention.

### DETAILED DESCRIPTION OF THE INVENTION

Multimedia Messaging Service (MMS) is a cross-vendor standard meant to elevate the capabilities of mobile messaging beyond that of the short text messages in SMS to include combinations of: text, graphics, animation, audio and (in the future) video. Like SMS, it is possible to send messages from person to person (mobile to mobile), e.g., by sending messages with images created using digital cameras built into the phones. However, it is expected that a larger portion of the MMS traffic will consist of messages created or processed by application servers. To accommodate the application servers, and the requirements for storing and forwarding messages, the MMS standards define the architecture that is depicted in FIG. 1.

At the core of the MMS environment is the Multimedia Messaging Service Centre (MMSC) 10, which is sometimes referred to as the MMS Relay/Server or MMS Proxy-Relay. Normally run by the network operator (or by a third party, under contract), the MMSC 10 is a computer system responsible for temporary storage of messages, message notification and message delivery to mobile devices 16. It transfers messages to and from mobile devices 16 through a WAP (Wireless Application Protocol) Gateway 12 via an interface 14 named MM1.

MMS applications that are run independently from the MMSC 10 are hosted on outside servers 20 that communicate with the MMSC via an interface 18 called MM7. These applications are called external applications. The particular type of application of interest is the originating external application. “Originating” means that the application is a source of new MMS messages, rather than being a process that consumes or transforms existing MMS messages.

The conversion software in accordance with the principles of the invention takes the form of an originating external application. It takes PowerPoints files and destination addresses (PLMN numbers) as input, generates MMS messages and sends them to an MMSC 10 via the MM7 interface 17. The MMSC 10 notifies the destination mobile phones (UE, or user equipment) of the messages, via the MM1 interface. The MMS User Agent (MMS software) on the mobile phones 16 will subsequently retrieve the MMS messages from the MMSC 10, via MM1 14, and display them to the recipients.

The WAP gateway 12 sits between the packet data network 22 (TCP/IP, Internet) and the public land mobile network 24 (WAP/WSP) and handles the transformation of packets as required. FIG. 2 illustrates the protocol stacks involved for the mobile phone, the WAP gateway, and the MMSC.

3GPP (Third Generation Partnership Project) defines the specifications that describe the high-level requirements and functional specifications for MMS. Different releases correspond to the various versions of MMS. For example, R-99 defines MMS1.0 and Rel-4 defines MMS1.1. Future versions of MMS are being defined by Rel-5 and Rel-6.

Three sets of technical specifications from OMA (Open Mobile Alliance, formerly the WAP forum) describe how the MM1 interface 14 is to be realized. They define the architecture, protocols, packaging and the types of media that will be supported by implementations of MMS.

These MMS specifications build upon existing industry standard specifications for message structure, packaging and protocols from other organizations such as IETF and W3C.

The industry standards of particular interest for MMS software are:
1. HTTP—The communication protocol used for application transactions with the MMSC.
2. RFC-2822—The format for messages and their headers.
3. MIME—The format for representing various media in messages.
4. SMIL—The XML-based scene description language used for MMS presentations.
5. SOAP—The XML-based format used for messages between applications and the MMSC.

FIGS. 3 and 4 show the role these standards have in the structure of MMS messages constructed for delivery over the MM1 and MM7 interfaces, and ho-w they will be used for MMS preparation software.

At the heart of the encapsulated MMS message are the parts that make up the actual presentation: SMIL layout, animated GIF images, AMR audio and UTF-8 text. Some additional formats such as JPEG are possible now, and others such as H.263 and MPEG-4 video will be possible in the future. In the conversion software, each PowerPoint slide and corresponding note will be transformed into an animated GIF image file, with accompanying AMR audio and UTF-8 text. Each slide in the generated MMS presentation will advance automatically, as specified within the generated SMIL layout.

While the use of industry standards simplifies the development of MMS software, difficulties are encountered in practice. For instance, several variations of SMIL are officially defined: Full SMIL, 3GPP SMIL, Basic SMIL and Conformance SMIL. Making matters worse, implementations of SMIL in the mobile phones from handset manufacturers and the software used by network operators diverge from what is defined in these standards.

Also, the basic media format support on the different available MMS-enabled mobile phones is not consistent from one model to the next, particularly for the early models.

The MMS Conformance document [OMA-MMSCONF] from OMA seeks to address the interoperability issues for future equipment and software. However, the conversion software will be designed to target existing MMS-enabled mobile phones, many of which do not conform. This will necessitate significant amounts testing on many different models. This will not be practical within the context of this project, but it is something about which to be mindful for future plans.

MMS conformance stipulates that MMS User Agents must handle MMS message dimensions up to 120 by 160 pixels. However, some MMS-enabled mobile phones have smaller screen dimensions than 120 by 160, leaving MMS User Agents 16 with an undersized display area. It is unknown what will happen to the message in this case. It is possible that the network or the mobile phone itself will scale or crop the presentation.

Embodiments of the invention focus on producing MMS messages targeting two display sizes: the 120 by 160 pixel area, and the larger display area provided by the MMS User Agent on the Sony Ericsson P800 mobile phone. See FIG. 5. Right-sizing output to accommodate different phone capabilities is beyond the scope of this project. The standards [OMA-UAPROF] specify how mobile phone manufacturers must build in device capabilities and preferences capabilities reporting facilities. However, it is not yet known if or how this information would be accessible via an Impatica originating external application.

MMS specifications do not stipulate any limit on the number of bytes of data for a message. However, restrictions on message size imposed by mobile device hardware and by network operators will probably the single most significant barrier to squeezing enough useful information into a single message, in a compelling multimedia format. Initial upper limits in various configurations so far have been: 30 KB, 45 KB and 100 KB.

Traditionally, audio has been the limiting factor in streaming for PowerPoint presentations (i.e., those without video). This has been kept in check through the use of a compact sound feature. In the case of MMS, AMR audio format will be the most broadly supported digitized audio format by MMS-enabled mobile phones. AMR audio can be encoded at rates ranging from 4.75 kbps to 12.2 kbps, with a tradeoff between size and quality. Mobile phones will support some subset of the bit rates allowed in the AMR audio format. The best that can be done by is to encode at the lowest acceptable bit rates that are supported by the target mobile phones.

The text encoding options are generally: US ASCII, UTF-8 and UTF-16, with UTF-8 being the preferred suitable format, assuming there is sufficiently broad support for it across models of mobile phones.

In the MMS software, each PowerPoint slide will be converted into an animated GIF file. The GIF format imposes some significant restrictions that do not apply in the same way to the PersonalJava and J2ME MIDP alternative approaches for mobile. For example, the GIF format allows only 256 colours throughout an entire image or animation. That means that only 256 colours may be used to display the contents of each slide. It would be possible to switch to JPEG compression to allow more colours on slides that do not have animation.

GIF is a format that uses lossless compression of its image data. However, there are both lossless and lossy techniques that may be applied to reduce the size of animated GIF. Lossless techniques include cropping of individual frames to include only changed pixels (it is not known to what extent this is supported by the target mobile phones) and LZW pixel pattern optimization. An example of a lossy technique is colour palette reduction (which can adversely affect the appearance of the image).

In an alternative embodiment the invention uses a novel lossless compression method for animated images that is particularly intended for use on devices with limited bandwidth, memory, and processing power, such as mobile phones and other wireless handheld devices.

An uncompressed pixel is, for instance as a 15 bit RGB value. Wherever possible an image is transmitted as compressed sequence of pixels matching a previous sequence in the previous frame, or possibly in the current frame. The compressed sequence is defined by an offset to the previous pixel sequence.

A processor, which could for example be a personal computer, examines the frame buffers to compare sequences of pixels in the current frame with a previous frame and looks for sequence matches with the maximum number of pixels. The pixel sequences are identified by a compression pointer, which is of variable size and consists of a pixel count and an offset to a previous pixel sequence. If the offset is zero then there is no change from the previous frame. For example, in the extreme case, if the current frame is identical to the previous frame, the entire pixel sequence making up the current frame will match the pixel sequence making up the previous frame. In this case the offset is zero, and the pixel count is equal to the size of the frame.

Runs of identical pixels are compressed by referencing a backward offset of one with a count less one of the number of duplicate pixels. Sequences of pixels can be repeated in the same way. If the offset is greater than the offset of the current pixel then it is a reference to the previous frame.

Once the current frame is built it is copied to the previous frame before the start of the next display cycle. The initial contents of the previous frame are set to a constant value, such as white.

For 15 bit RGB compression of small frame sizes (<64 Kbytes) the following field widths are used in the preferred embodiment. This configuration is for illustrative purposes only, as this compression method can be used with any format input pixel or frame size.

| 16 bit pixel: | 1 rrrrr ggggg bbbbb |
|---|---|
| 8 bit compression pointer:0 ii nnnn | |
| ii = 0: | offset 0 (skip) |
| ii = 1: | offset 1 (duplicate) |
| ii = 2: | offset = following byte + 2 |
| ii = 3: | offset = following 2 bytes + 2 |
| nnnn = 0: | count = following byte + 32 |
| If following byte = 255, then count = two following bytes + 32. | |
| nnnn = 1-31: | sequence length 1..31 |

In implementing the invention the processor compares possible sequences of pixels to look for the maximum number of pixels that match. In this way, optimum compression is achieved.

The detailed implementation is shown in FIG. 6 by way of example. At step 60, integer i is set to N, where N is the number of pixels in a frame. At step 61, the processor looks to see if i is less than twice N, and if not stops the process. If integer I is less than twice N, the processor initially set values maxi and maxn to zero, and sets integer j=i−1 at step 62.

At step 63, the processor determines whether j is greater than or equal to zero. If not, the processing shifts to setp 64. If yes, the variable matchn is set to zero at step 65 and the determines whether the value i+matchn is less than two times N and the value B[I+matchn]=B[j+matchn] at step 66. The processor then increments the variable matvhn at step 67 and determines whether matchn>maxn at step 68. If not, the processor repeats step 66, If yes, the processor moves to step 69 and sets maxi=I−j and maxn=matchn before returning to step 66. When the result of performing step 66 is negative, the processor sets j=j−1 at step 70 and returns to step 63.

The compression pointer is output at step 71, following which the integer I is set to I+maxn, whereupon the processor returns to step 61.

The described method has a number of advantages. Animation playback is simple and requires no memory other than two frame buffers (which are typically needed anyway to support transition effects such as dissolve). The input is byte aligned for quick access. The unit of compression is a pixel, not a byte, and so the compression is not sensitive to the number of bits per pixel. The common cases of no change from the previous frame and duplicated pixels are coded with the fewest bits. The entire previous frame can be used as a compression source for moving images.

The invention allows PowerPoint presentations to be transformed into compelling MMS messages and sent successfully as compressed files to mobile phones or other mobile display devices, where they are decompressed and displayed for viewing. The invention is also particularly applicable to portable messaging devices, such as the Research-in-Motion Blackberry™.

The following reference materials are herein incorporated by reference:
[3G-22.140-R99] Third Generation Partnership Project. 3G TS 22.140 Release 1999: Technical Specification Group Services and System Aspects; Service Aspects; Stage 1, Multimedia Messaging Service. June 2000.
[3G-22.140-Rel4] Third Generation Partnership Project. 3GPP TS22.140 Release 4: Technical Specification Group Services and System Aspects; Service Aspects; Stage 1, Multimedia Messaging Service. December 2002.
[3G-22.140-Rel5] Third Generation Partnership Project. 3GPP TS 22.140 Release 5: Technical Specification Group Services and System Aspects; Stage 1, Multimedia Messaging Service. December 2002.
[3G-22.140-Rel6] Third Generation Partnership Project. 3GPP TS 22.140 Release 6: Technical Specification Group Services and System Aspects; Stage 1, Multimedia Messaging Service. June 2003.
[3G-23.140-R99] Third Generation Partnership Project. 3GPP TS 23.140 Release 1999: Technical Specification Group Terminals; Multimedia Messaging Services (MMS); Functional Description, Stage 2. June 2002.
[3G-23.140-Rel4] Third Generation Partnership Project. 3GPP TS 23.140 Release 4: Technical Specification Group Terminals; Multimedia Messaging Services (MMS); Functional Description; Stage 2. June 2003.
[3G-23.140-Rel5] Third Generation Partnership Project. 3GPP TS23.140 Release 5: Technical Specification Group Terminals; Multimedia Messaging Services (MMS); Functional Description; Stage 2. June 2003.
[3G-23.140-Rel6] Third Generation Partnership Project. 3GPP TS 23.140 Release 6: Technical Specification Group Terminals; Multimedia Messaging Services (MMS); Functional Description; Stage 2. June 2003.
[3G-26.140-Rel5] Third Generation Partnership Project. 3GPP TS 26.140 Release 5: Technical Specification Group Services and System Aspects; Multimedia Messaging Service (MMS); Media formats and codes. December 2002.
[3G-32.235-Rel4] Third Generation Partnership Project. 3GPP TS 32.235 Release 4: Technical Specification Group; Telecommunication management; Charging management; Charging data description for application services. June 2003.
[3G-32.235-Rel5] Third Generation Partnership Project. 3GPP TS 32.235 Release 5: Technical Specification Group; Telecommunication management; Charging management; Charging data description for application services. June 2003.
[APPLE-QT-INTER] Apple Computer, Inc. Interactive Movies. October 2002.
[ED-030902] E. Doyle. Re: Mobile Business. E-mail, Sep. 2, 2003.
[GUTHERY-03] S. B. Guthery and M. J. Cronin. Developing MMS Applications: Multimedia Messaging Services for Wireless Networks. McGraw-Hill, Jun. 18, 2003.
[ITU-H.263] International Telecommunications Union. ITU-T H.263: Video coding for low bit rate communication. February 1998.
[LEBODIC-03] G. Le Bodic. Mobile Messaging Technologies and Services: SMS, EMS and MMS. Wiley, January 2003.
[LONGUEUIL-02] D. J. Longueuil. Wireless Messaging Demystified: SAS, EMS, MMS, IM, and others. McGraw-Hill, Oct. 23, 2002.
[N-EAI-FAQ] Nokia Corporation. External Application Interface Frequently Asked Questions.
[N-EA-DEVGUIDE] Nokia Corporation. External Applications Developer's Guide. 2002.
[N-GS-MMS] Nokia Corporation. Getting Started with MMS. Jun. 25, 2003.
[N-GS-NM-TOOLS] Nokia Corporation. Getting Started with Nokia MMS Tools. Jun. 12, 2003.
[N-HOWTO-MMS] Nokia Corporation. How to Create MMS Services. Jun. 26, 2003.
[N-JAPI-MMSC] Nokia Corporation. Java API Developer's Guide for Multimedia Messaging Service Center. June 2003.
[N-MIGRATING] Nokia Corporation. Migrating to MMS. Apr. 25, 2002. Apr. 25, 2002.
[N-MMSC-ADG] Nokia Corporation. MMS Center Application Development Guide, Version 1.0. Apr. 3, 2002.
[N-NDS-MMS] Nokia Corporation. Nokia Developer's Suite for MMS Version 1.0. February 2003.
[N-NMM-WPAPER] Nokia Corporation. Nokia Multimedia Messaging White Paper. 2001.
[N-NPHO-MCHAR] Nokia Corporation. Nokia Phone Messaging Characteristics. Jun. 16, 2003.
[N-UP-APPS-MMS] Nokia Corporation. Upgrading Applications to MMS. Jun. 7, 2002.
[OMA-ERELD] Open Mobile Alliance. Enabler Release Definition for MMS Version 1.1. Nov. 4, 2002.
[OMA-MMSARCH] Open Mobile Alliance. Multimedia Messaging Service, Architecture Overview, Version 1.1. Nov. 1, 2002.
[OMA-MMSCONF] Open Mobile Alliance. MMS Conformance Document, Version 2.0.0. Feb. 6, 2002.
[OMA-MMS-CTR] Open Mobile Alliance. Multimedia Messaging Service, Client Transactions, Version 1.1. Oct. 31, 2002.
[OMA-MMS-ENC] Open Mobile Alliance. Multimedia Messaging Service, Encapsulation Protocol, Version 1.1. Oct. 30, 2002.
[OMA-UAPROF] Open Mobile Alliance. WAG UAProf. Oct. 20, 2001.
[RFC-822] Internet Engineering Task Force. RFC-822: Standard for the Format of ARPA Internet Text Messages. Aug. 13, 1982.
[RFC-2045] Internet Engineering Task Force. RFC-2045: Multipurpose Internet Mail Extensions (MIME) Part One: Format of Internet Message Bodies. November 1996.
[RFC-2046] Internet Engineering Task Force. RFC-2046: Multipurpose Internet Mail Extensions (MIME) Part Two: Media Types. November 1996.
[RFC-2047] Internet Engineering Task Force. RFC-2047: Multipurpose Internet Mail Extensions (MIME) Part Three: Message Header Extensions for Non-ASCII Text. November 1996.
[RPC-2048] Internet Engineering Task Force. RFC-2048: Multipurpose Internet Mail Extensions (MIME) Part Four: Registration Procedures. November 1996.
[RFC-2049] Internet Engineering Task Force. RFC-2049: Multipurpose Internet Mail Extensions (MIME) Part Five: Conformance Criteria and Examples. November 1996.
[RFC-2822] Internet Engineering Task Force. RFC-2822: Internet Message Format. April 2001.
[WAP-205] WAP Forum. WAP-205, WAP MMS Architecture Overview. Apr. 25, 2001.
[WAP-206] WAP Forum. WAP-206, WAP MMS Client Transactions, Jan. 15, 2002.
[WAP-209] WAP Forum. WAP-209, Wireless Application Protocol, MMS Encapsulation Protocol. Jan. 5, 2002.

1. A method of preparing MMS messages comprising:
preparing a multimedia presentation on a computer using an industry-standard multimedia format;
exporting a file containing said multimedia presentation in said industry-standard format; and
processing said file to create an MMS message suitable for transmission over a mobile messaging service.

2. A method as claimed in claim 1, wherein said mobile messaging service is a mobile phone service.

3. A method as claimed in claim 1, wherein said mobile messaging service is a wireless service offering electronic mail and multimedia browsing.

4. A method as claimed in claim 1, wherein said multimedia presentation is created using a presentation software package.

5. A method as claimed in claim 4, wherein said presentation software package is Powerpoint.

6. A method as claimed in claim 1, wherein said multimedia presentation is first converted to an animated image file.

7. A method as claimed in claim 6, wherein said animated image file is an animated GIF file.

8. A method as claimed in claim 6, wherein said animated image file is compressed by matching a subsequent sequence of pixels defining an animated image with a previous sequence, and said subsequent sequence is identified with the aid of an offset relative to said previous sequence, and said compressed animated image file is transmitted over said mobile message service for display on a mobile device.

9. A method as claimed in claim 8, wherein said compressed image file

10. A method as claimed in claim 9, wherein said subsequent pixel sequence is identified by a compression pointer comprising a pixel count and an offset to the previous pixel sequence.

11. A method of compressing images, comprising:
comparing a subsequent sequence of pixels with previous sequences of pixels to find a match; and
identifying the subsequent sequence of pixels by an offset relative to said previous sequence of pixels.

12. A method as claimed in claim 11, wherein said subsequent sequence is in a current frame, and said previous sequences are in a previous frame, and said offset represents the difference between the position of the subsequent sequence in the current frame and the position of the matching sequence in the previous frame.

13. A method as claimed in claim 12, comprising examining said frames to identify matching pixel sequences with the maximum length.

14. A method as claimed in claim 11, wherein said subsequent sequence is identified by a compression pointer, which includes the offset from the previous frame and a count value representing the number of pixels in the sequence.
